(19) United States
(12) Patent Application Publication
(10) Pub. No.: US 2014/0354582 A1
(43) Pub. Date: Dec. 4, 2014

(54) Touch Sensor For Mobile Device With Radio

(71) Applicant: Silicon Laboratories Inc., Austin, TX (US)

(72) Inventors: Nicholas Horne, Over (GB); Philip Jones, Cottenham (GB)

(73) Assignee: Silicon Laboratories Inc., Austin, TX (US)

(21) Appl. No.: 13/905,500

(22) Filed: May 30, 2013

(51) Int. Cl. G06F 3/044

(52) U.S. Cl. CPC G06F 3/044
USPC 345/174

(57) ABSTRACT

An integrated circuit that includes a wireless transceiver and a touchpad detection circuit is disclosed. The integrated circuit includes oscillators in the pad area of the device, thus minimizing silicon area used for this function. The oscillators consist of an inverting input buffer, such as a Schmidt trigger with a resistive feedback path from the output of the input buffer back to its input. The input of the buffer is also in communication with the external connection pad within the pad area. This allows an external component, such as a capacitor or touch sensor to be coupled to the oscillator. The method of operating a touchpad is also disclosed, where the oscillators may be selectively enabled.

### BACKGROUND

It is becoming increasing common to utilize battery powered communications devices. Various low-power communications protocols have been developed to exploit this trend. For example, BlueTooth®, ZigBee® and other IEEE802.15 protocols, are all wireless pan area network (WPAN) standards.

While devices that utilize these protocols may operate using battery power, they still have high levels of functionality. For example, these devices include processing units, input devices and other functions. One such input device may be a touch sensor. These devices operate based on measured changes in capacitance, typically caused by the pressing of a button by a finger. Because small variations in capacitance are being measured, touch sensors are very sensitive to variations in supply voltage.

In battery power devices, especially those with radio transceivers, it is not uncommon for the supply voltage to vary as a function of battery charge and electrical loading. In addition, the space in which the required circuitry must fit is also constrained in these types of devices.

Consequently, it would be beneficial if there were a circuit which allows the simultaneous use of a touch sensor and a radio transceiver. It would be beneficial if such a circuit utilized minimal space, allowed maximal flexibility and was not susceptible to cross-talk or injection lock.

### SUMMARY

An integrated circuit that includes a wireless transceiver and a touchpad detection circuit is disclosed. The integrated circuit includes oscillators in the pad area of the device, thus minimizing silicon area used for this function. The oscillators consist of an inverting input buffer, such as a Schmidt trigger with a resistive feedback path from the output of the input buffer back to its input. The input of the buffer is also in communication with the external connection pad within the pad area. This allows an external component, such as a capacitor or touch sensor to be coupled to the oscillator.

According to one embodiment, a system including touch detection is disclosed. The system comprises a plurality of input pins coupled to a plurality of external connection pads within a pad area for an integrated circuit (IC); a plurality of oscillators located within the pad area for the IC, each oscillator being coupled to at least one input pin and being configured to output an oscillating signal having a frequency dependent upon a touch sensor coupled to the at least one input pin; and touch detection circuitry coupled to receive the oscillating signals from the plurality of oscillators and configured to output touch detection signals based upon changes to the oscillating signals. In some embodiments, the output touch detection signals may represent the period of frequency of the oscillating signals.

According to another embodiment, a touch pad monitoring system is disclosed, which comprises an integrated circuit (IC), having a general purpose I/O (GPIO) pin, adapted to be in communication with a touch sensor, comprising an inverting input buffer, disposed in a pad area of the IC and comprising an input in communication with the GPIO pin, an output, and a resistive feedback path, disposed in the pad area, connecting the output of the input buffer to the input of the input buffer; wherein the inverting buffer and the resistive feedback path comprise an oscillator, the frequency of which is dependent on the touch sensor coupled to the GPIO pin.

According to a third embodiment, a method of operating a touchpad is disclosed. This method comprises providing a plurality of touch sensors, defining the touch pad; a reference capacitor; a reference inverting input buffer having a resistive feedback path from its output to its input, where its input is in communication with the reference capacitor, thereby forming a reference oscillator; a reference period measurement block in communication with the output of the reference inverting input buffer to measure a period of the reference oscillator; a plurality of inverting input buffers, each having a respective resistive feedback path from its output to its input, where each input is in communication with a respective one of the plurality of touch sensors to create a plurality of oscillators; two multiplexers, each having a plurality of inputs, each input in communication with an output of a respective one of the plurality of input inverting buffers, each of the multiplexers having a respective output, selectable from the plurality of inputs; and two period measurement blocks, each in communication with a respective output of one of the two multiplexers to measure a period of one of the touch sensors; selecting two of the touch sensors to monitor by configuring the multiplexers to select an input corresponding to the two touch sensors to pass to the respective outputs; enabling the reference period measurement block and the two period measurement blocks to simultaneously measure a period of the reference oscillator and the two touch sensors, respectively; reading the measured periods of the reference oscillator and the two touch sensors; creating ratios of the measured periods of the two touch sensors to the reference oscillator to compensate for variations in voltage; and comparing the created ratios to average values to determine whether a touch sensor is being actuated.

### BRIEF DESCRIPTION OF THE FIGURES

For a better understanding of the present disclosure, reference is made to the accompanying drawings, which are incorporated herein by reference and in which:

FIG. 1 is a block diagram of a system according to a first embodiment;

FIG. 2 is a schematic representation of the touch sensor circuit of FIG. 1;

FIG. 3 is a representative flow chart of the interrupt service routine used with the touch sensor circuit of FIG. 2; and

FIG. 4 is a representative flow chart of a deferred service routine used with the touch sensor circuit of FIG. 3.

### DETAILED DESCRIPTION

As described above, low power battery-operated devices are becoming more prevalent. At the same time, consumers demand the same functionality from these lower power devices. For example, devices may include radio transceivers, processing units, as well as touch sensors.

Touch sensors operate based on measured changes in capacitance, typically caused by the pressing of a button by a finger. However, touch sensors are very sensitive to variations in supply voltage. Thus, for battery operated devices, reliable operation of a touch sensor can be difficult. First, as the battery discharges, the supply voltage may droop somewhat. In addition, the battery has limited output capability. Therefore, when large instantaneous current surges occur, it is common for the voltage supply to experience a drop in voltage. These changes in supply voltage can be misinterpreted by the circuitry as a change in capacitance caused by a touch.

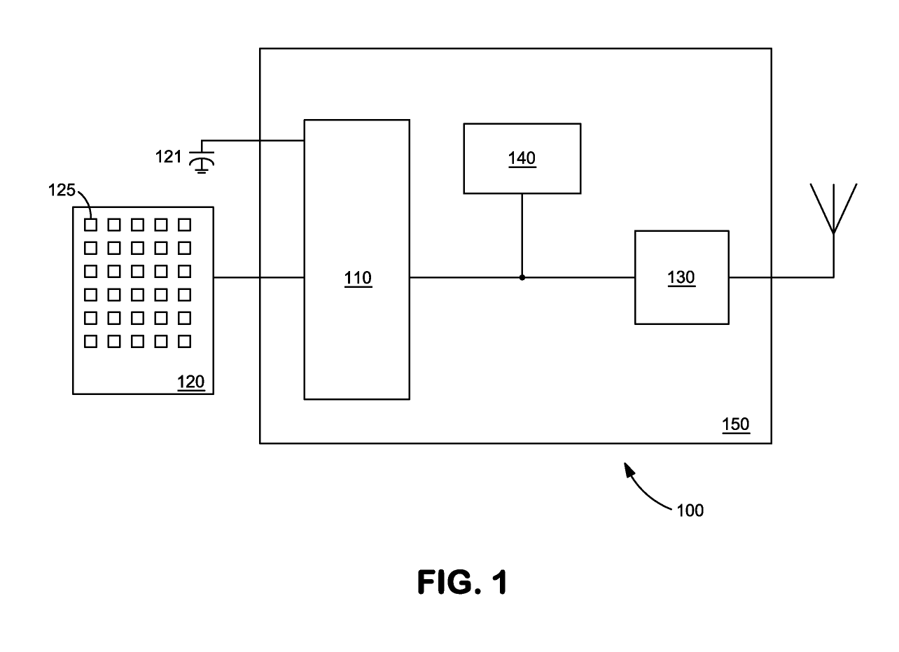

FIG. 1 shows a system 100 having a touch sensor circuit 110, a touch pad 120, which are represented as variable capacitors, a radio transceiver 130 and a processing unit 140. This device is powered by a battery (not shown). The touch sensor circuit 110, the radio transceiver 130 and the processing unit 140 may be incorporated into a single electronic device 150. The single electronic device 150 may be an integrated circuit (IC).

The radio transceiver 130 may be used for a WPAN protocol, such as BLUETOOTH, BLUETOOTH low energy (BTLE), ZIGBEE® or other IEEE802.15.4 standards. Typically, radio transceivers use little power when in receive mode or idle mode. However, their power consumption increases dramatically when the transceiver is transmitting to other devices. In addition, this change in power consumption may be nearly instantaneous. This high power consumption, as explained above, may cause variations in the supply voltage, due to the inability of the battery to respond instantaneously to varying loads. In addition, batteries cannot provide unlimited power. Thus, supply voltages within system 100 may not be stable.

The radio transceiver 130 may include digital components, such as baseband processing, storage elements and control logic. In addition, it may include analog circuitry which drives radio operation.

The touch pad 120 may include a plurality of touch sensors 125, arranged in any desired configuration. In some embodiments, 48 touch sensors 125 may be provided. However, any other number of touch sensors 125 may also be used. The touch pad 120 is disposed outside of the electronic device 150. In addition, the system 100 may also include a reference capacitor 121. This reference capacitor 121 is disposed outside of the electronic device 150, such that it cannot be affected by user touch. In other words, its value does not vary based on user interaction. This characteristic allows this reference capacitor 121 to be used to monitor variations or fluctuations in the supply voltage and temperature, as described in more detail below. In some embodiments, the reference capacitor 121 is a capacitor having a fixed value. In other embodiments, the reference capacitor 121 is a touch sensor which is not accessible to the user.

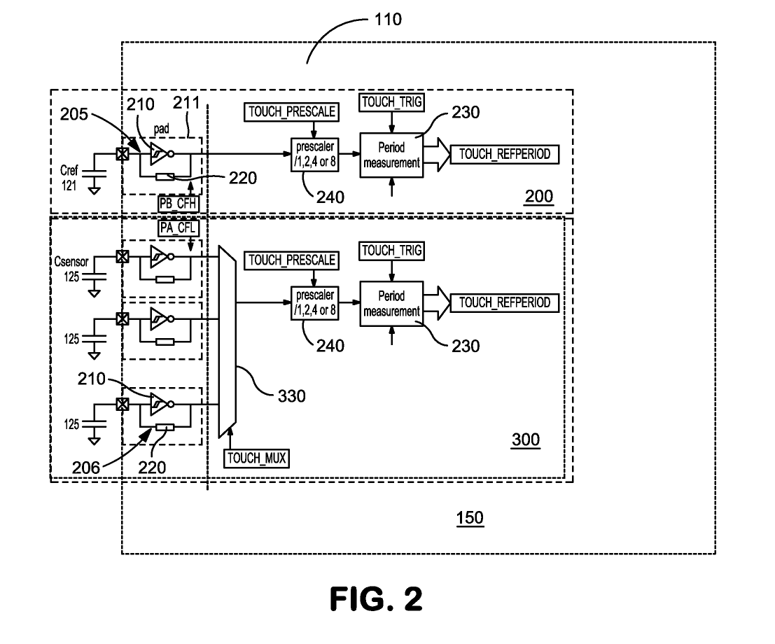

FIG. 2 shows a schematic of the touch sensor circuit 110 and the touch pad 120. As shown in FIG. 1, most of the touch sensor circuit 110 is disposed within an electronic device 150. Although no other circuitry is shown, it is understood that the electronic device 150 may include many other functions, such as a processing unit 140 and the radio transceiver 130, in addition to the touch sensor circuit 110. In this figure, touch sensors 125 are disposed outside the electronic device 150 and are represented as capacitors. The touch sensor circuit 110 includes a reference frequency circuit 200 and a touch pad sensor circuit 300. The reference capacitor 121 is in electrical contact with the reference frequency circuit 200 by way of an input buffer 210. This input buffer 210 is disposed in the pad area 211 of the electronic device 150, (i.e. at the interface between the interior of the electronic device 150 and the surroundings), and may be a Schmitt-trigger inverter. The inverting input buffer 210 includes a resistive path 220, also disposed in the pad area 211, which connects the output of the buffer, which interfaces with the interior of the electronic device 150, back to the input, which is in communication with the surroundings. This resistive path 220 in combination with the external reference capacitor 121, which is disposed outside the electronic device 150, forms an RC circuit. This RC circuit, when connected to the Schmitt-trigger inverter 210, forms a reference oscillator 205. Thus, the reference oscillator 205 is formed of two components (inverting buffer 210 and resistor 220) disposed in the pad area 211. An external capacitor 121 is used to vary the frequency of the oscillator. The output of buffer 210 is an oscillating signal and represents the output of reference oscillator 205. The frequency of this reference oscillator 205 is determined by the value of resistor in the resistive path 220, the value of the reference capacitor 121, the input threshold of the inverting input buffer 210 and the supply voltage. Since the first three parameters listed are typically fixed for the reference circuit 200, this circuit 200 can be used to measure variations in supply voltage and temperature.

To measure the frequency, a period measurement block 230 is used. This period measurement block 230 receives signal which represents a prescaled version of the reference oscillator frequency, which may be pre-scaled by prescaler 240. The prescaler 240 may be used to reduce the frequency of the oscillating signal by a value, such as 1, 2, 4 or 8. Of course, other prescale values may also be used. The prescale value may be selected using a register, labeled as TOUCH_PRESCALE in FIG. 2, writable by the processing unit 140. The period measurement block 230 also receives a fixed frequency input, such as 12 MHz, although other values may also be used. The period measurement block 230 counts the number of fixed frequency periods that occur during a specified number of periods of the reference oscillator frequency, or a prescaled version thereof. Once the specified number of periods has occurred, the period measurement block 230 stops counting and holds the final value in a register, labeled as TOUCH_REFPERIOD in FIG. 2, until it is restarted. In some embodiments, an 8 bit counter and register are used. In other embodiments, a 16 bit, 32 bit or 64 bit counters and registers may be employed.

The prescaler 240 is used to keep the frequency that is received by the period measurement block 230 within an appropriate range. If the frequency received by the period measurement block 230 is too low, the counter within the period measurement block 230 will overflow, resulting in an erroneous value. Conversely, if the frequency received by the period measurement block 230 is too high, the resulting count will be too small to adequately distinguish changes due to a touch.

In some embodiments, the reference capacitor 121 is in electrical communication with a General Purpose Input/Output (GPIO) pin. As is known, GPIO pins are disposed at the pad area 211 of the electronic device 150, so as to interface with circuits or other functions that are external to the electronic device 150. This GPIO pin, which can be configured in a number of ways. In each instance, the GPIO is in communication with an external connection pad, thereby allowing connection to a device or component disposed outside the device 150. The GPIO can be configured to have a resistive feedback path 220 between its input and its output as shown in FIG. 2. It may be configured to perform other functions. For example, the GPIO pin may be an output, an input or a bidirectional function. In addition, although not shown, the GPIO pin is also in communication with other functions, where a configuration register, labeled as PB_CFH in FIG. 2, written by the processing unit 140, is used to select the function performed by the GPIO pin. It should be noted that in some embodiments, the inverting input buffer 210 can be disabled so that the touch sensor capacitors 125 do not charge and discharge. For example, the resistive feedback path 220 may be electrically disconnected, thereby allowing the touch sensor capacitor to float. The switch used to electrically disconnect the resistive feedback path 220 may also be disposed in the pad area 211. In another embodiment, the input to the inverting input buffer 210 may be electrically connected to ground to discharge the touch sensor capacitors 125 and maintain them in this state. These features can be used to reduce the number of oscillating signals that enter the device 150 as described in more detail below.

The touch pad sensor circuit 300, like the reference circuit 200, utilizes GPIO pins incorporating Schmitt-trigger inverters 210 having resistive feedback paths 220, where the inverters 210 and resistive feedback paths 220 are disposed in the pad area 211. The inverter 210 and resistive feedback path 220 form an oscillator 206. The frequency of each of these oscillators 206 is varied by virtue of their connection to a respective touchpad 125. As described above, each touch pad 125, which are disposed external to the electronic device 150, may be in communication with a separate GPIO pin. These GPIO pins may be used for the touch pad function described herein, or for other functions. Also, as described above, each GPIO pin can also be programmed to cause oscillations to stop if desired.

Prescalers 240 and period measurement blocks 230 are also utilized, performing the same functions as described above. Unlike the reference circuit 200, in some embodiments, the touch pad sensor circuit 300 also includes a plurality of multiplexers 330. The outputs from a subset of the plurality of GPIO pins are in communication with each multiplexer 330. In one embodiment, there are 8 multiplexers 330, each receiving inputs from 6 GPIO pins. In other words, up to 48 GPIO pins may be dedicated to the touch pad sensor operation. However, a smaller number of GPIO pins may be dedicated to this function as well. In addition, a different number of multiplexers 330, or inputs per multiplexer 330 may be used. A particular input from the multiplexer 330 can be selected by writing to a particular register. In some embodiments, all of the multiplexers 330 are controlled with a single register, labeled as TOUCH_MUX in FIG. 2. In other embodiments, separate registers are used for each multiplexer 330.

It is noted that the circuitry described herein occupies the same amount of silicon, regardless of whether one GPIO pin is used, or all 48 GPIO pins are dedicated to the touchpad function. This permits greater flexibility for the user to define the operation of the device. This circuitry can also be scaled to accommodate more GPIO pins, if necessary, such as by having more GPIOs associated with each multiplexer, or by the addition of more multiplexers. For example, in one embodiment, there are 8 multiplexers 330, 8 prescalers 240 and 8 period measurements blocks 230. These components can be used to control a touchpad having between 1 and 48 touch sensors. If the number of inputs to each multiplexer 330 is increased to 8, up to 64 touch sensors can be supports, assuming 64 GPIO pins are available.

In addition, most of the oscillator circuit (i.e. the inverting buffer 210 and resistor 220) is disposed in the pad area 211, and therefore does not occupy any area within the electronic device 150. Thus, creation of the oscillators 206 needed to implement a touch pad detection circuit does not use any silicon area.

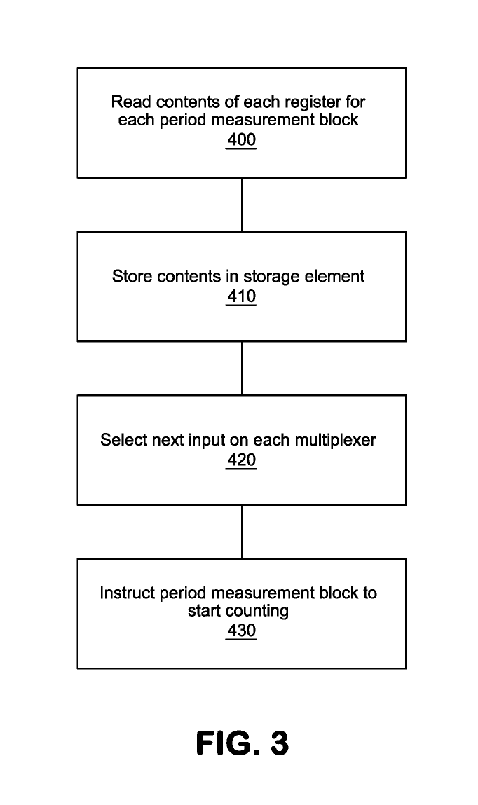

In operation, an interrupt service routine may be used to monitor the touch pad. Based on the implementation of FIG. 2, up to 8 touch sensors can be monitored simultaneously (i.e. one per multiplexer). FIG. 3 shows an exemplary flow chart for this interrupt service routine (ISR). When the ISR is called, it reads the value of each period measurement block 230, including the one in the reference circuit 200, as shown in step 400. These values are available in a register, labeled TOUCH_REFPERIOD in FIG. 2, and are then stored in a storage element (not shown) for further processing at a later time, as shown in step 410. The ISR then selects the next set of touch pads (by changing the selector for each multiplexer 330), as shown in step 420. In some embodiments, the input to all of the multiplexers 330 can be changed by a single operation, such as writing a register (TOUCH_MUX) in the electronic device 150. In other embodiments, each multiplexer 330 must be individually reconfigured by writing a plurality of registers. The ISR then instructs each period measurement block 240 to start counting clock periods, as shown in step 430. This may be achieved by writing a register, labeled TOUCH_TRIG in FIG. 2, in the electronic device 150. This ends the ISR. The ISR is then called again after a suitable period of time, such as 10 milliseconds. In some embodiments, the ISR is called more frequently if multiple banks are used. A bank is defined as a set of GPIO pins that are in communication with the same input on different respective multiplexers 330. For example, all of the GPIOs that are in communication with input 0 of their respective multiplexers 330 would be designated Bank 0. Similarly, all GPIOs that are in communication with input 1 of their respective multiplexers 330 would be designated Bank 1. For example, the ISR may be run every T milliseconds, where this time is equal to 10 milliseconds divided by the number of banks utilized. In this way, the entire touch pad is sampled once every 10 milliseconds. Of course, other suitable time durations may also be used.

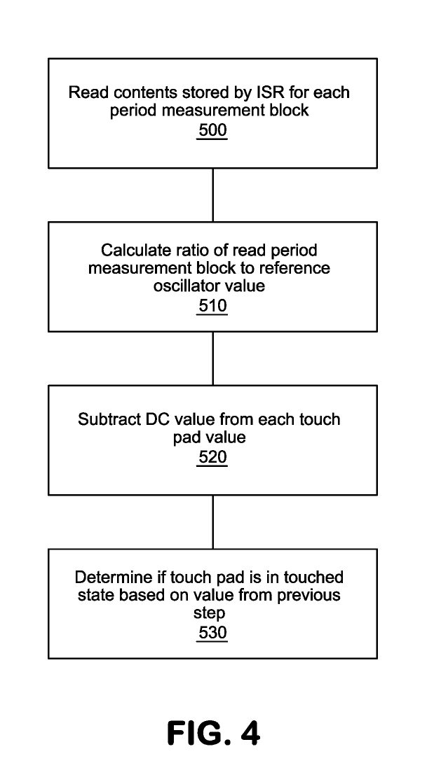

A deferred service routine (DSR) operates using the data saved during step 410. This DSR may be executed less frequently than the ISR, such as every 40 milliseconds or greater. An example flowchart of the DSR is shown in FIG. 4. First, as shown in step 500, the DSR reads each value that was stored in step 410. The DSR then calculates the ratio of the frequency of each touch pad oscillator 206 to the frequency of the reference oscillator 205, as shown in step 510. As described above, the reference oscillator 205 is used to track variations in supply voltage or temperature. Thus, by calculating ratios of the frequencies of the various touch pads to the reference oscillator, the effect of varying supply voltage or temperature can be compensated for. The DSR then subtracts the DC value of each touch pad from its latest value, as shown in step 520. This DC value is based on the running average value of each touchpad in its untouched state. In some embodiments, an infinite impulse response (IIR) digital filter is used to track the DC value. Other embodiments are also possible. The resulting value is then used to determine whether a particular touch pad is in the touched state, as shown in step 530. Additional steps can be performed to better refine the DC value of each touch pad if desired.

The use of a reference oscillator 205 allows the device 100 to be immune to variations in supply voltage. Other considerations may also be important in a small battery powered device. For example, in some embodiments, the touch pads 125 may be located close to one another, and the signal lines on the circuit board leading from the individual touch sensors to the electronic device 150 may also be located near one another. Oscillators near one another may be subject to injection locking, where a first oscillator may be disturbed by a second oscillator having a similar frequency. To alleviate this phenomenon, the electronic device 150 may be configured such that adjacent GPIO pins on the device 150 are connected to different multiplexers 330. In some embodiments, adjacent pins on electronic device 150 are associated with different banks. In some other embodiments, adjacent GPIO pins are associated with different banks on different multiplexers 330. For example, pin 0 may be Bank 0, multiplexer 0, while the adjacent pin is on Bank 1, multiplexer 1. This may help minimize injection locking.

Another technique to minimize injection locking is the ability to disable oscillators that are not being presently used. For example, as described above, only 8 touch sensors are being measured at any given time (i.e. one per multiplexer 330). Therefore, it is possible to disable all of the other oscillators by disconnecting the resistive feedback loop 220, or by some other method. In this way, only one signal on each multiplexer 330 is oscillating at a time. In addition, by proper arrangement of the GPIO pins, these oscillating signals are not adjacent pins on the device 150. In fact, by proper arrangement of the pins, these oscillating signals may be N pins away from each other, where N is the number of multiplexers 330 used in the circuit.

In another embodiment, oscillation of all of the GPIO pins, except one, may be disabled, such that only one touch pad is oscillating at a time. This completely eliminates the possibility of injection locking. This extends the time required to scan the touch pad, as only one value is read during each ISR.

In yet another embodiment, external load capacitors may be disposed in parallel with each touch pad. These external load capacitors may be of different values, such that each touch pad oscillator has a different default frequency. In this embodiment, the contribution of the external load capacitor may be subtracted (or added) to the value read in step 500 (FIG. 5) prior to calculating the ratio, as shown in step 510. By deliberately changing the default frequencies of the touch sensors, the probability of injection locking is much reduced.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system including touch detection, comprising:
a plurality of input pins coupled to a plurality of external connection pads within a pad area for an integrated circuit (IC);
a plurality of oscillators located within the pad area for the IC, each oscillator being coupled to at least one input pin and being configured to output an oscillating signal having a frequency dependent upon a touch sensor coupled to the at least one input pin; and
touch detection circuitry coupled to receive the oscillating signals from the plurality of oscillators and configured to output touch detection signals based upon changes to the oscillating signals.

2. The system of claim 1, further comprising transceiver circuitry within the IC configured to receive and to transmit radio frequency (RF) signals.

3. The system of claim 1, wherein each oscillator comprises a Schmidt trigger.

4. The system of claim 3, wherein each oscillator further comprises a resistive feedback path coupled between an input and an output of the Schmidt trigger.

5. The system of claim 1, wherein the touch detection circuitry comprises a multiplexer coupled to receive a plurality of oscillating signals and to output one of the oscillating signals based upon a control signal.

6. The system of claim 5, wherein the control signal to the multiplexer is dependent upon a programmable register within the integrated circuit.

7. The system of claim 2, wherein the transceiver circuitry is configured to receive and transmit signals according to a ZigBee standard.

8. The system of claim 5, wherein the touch detection circuitry comprises a second multiplexer and adjacent input pins are in communication with different multiplexers.

9. A touch pad monitoring system, comprising:
an integrated circuit (IC), having a general purpose I/O (GPIO) pin, adapted to be in communication with a touch sensor, comprising:
an inverting input buffer, disposed in a pad area of the IC and comprising an input in communication with the GPIO pin, an output, and a resistive feedback path, disposed in the pad area, connecting the output of the input buffer to the input of the input buffer;
wherein the inverting buffer and the resistive feedback path comprise an oscillator, the frequency of which is dependent on the touch sensor coupled to the GPIO pin.

10. The touch pad monitoring system of claim 9, wherein the resistive feedback path is selectively disconnected based on a control signal, thereby disabling the oscillator.

11. The touch pad monitoring system of claim 10, wherein the control signal is dependent upon a programmable register within the IC.

12. A method of operating a touchpad, comprising:
providing a plurality of touch sensors, defining the touch pad; a reference capacitor; a reference inverting input buffer having a resistive feedback path from its output to its input, where its input is in communication with the reference capacitor, thereby forming a reference oscillator; a reference period measurement block in communication with the output of the reference inverting input buffer to measure a period of the reference oscillator; a plurality of inverting input buffers, each having a respective resistive feedback path from its output to its input, where each input is in communication with a respective one of the plurality of touch sensors to create a plurality of oscillators; two multiplexers, each having a plurality of inputs, each input in communication with an output of a respective one of the plurality of input inverting buffers, each of the multiplexers having a respective output, selectable from the plurality of inputs; and two period measurement blocks, each in communication with a respective output of one of the two multiplexers to measure a period of one of the touch sensors;
selecting two of the touch sensors to monitor by configuring the multiplexers to select an input corresponding to the two touch sensors to pass to the respective outputs;
enabling the reference period measurement block and the two period measurement blocks to simultaneously measure a period of the reference oscillator and the two touch sensors, respectively;
reading the measured periods of the reference oscillator and the two touch sensors;
creating ratios of the measured periods of the two touch sensors to the reference oscillator to compensate for variations in voltage; and
comparing the created ratios to average values to determine whether a touch sensor is being actuated.

13. The method of claim 12, further comprising:
selecting a second two of the touch sensors and repeating the enabling, reading, creating and comparing steps.

14. The method of claim 12, further comprising a third touch sensor, different than the two touch sensors, comprising:
disabling an inverter input buffer in communication with the third touch sensor during the enabling step so as to reduce the possibility of injection locking.

15. The method of claim 12, wherein the reference inverting input buffer, the reference period measurement, the plurality of inverting input buffers, the two multiplexers, and the two period measurement blocks, are disposed within an electronic device, the method further comprising:
disposing the two touch sensors on non-adjacent pins of the electronic device.

16. The method of claim 12, further comprising disposing an external load capacitor in parallel with one of the two touch sensors to affect a frequency of its respective oscillator.
